(19) United States
(12) Patent Application Publication
(10) Pub. No.: US 2013/0042679 A1
(43) Pub. Date: Feb. 21, 2013

(54) Chip-Scale Optomechanical Gravimeter

(71) Applicants: Chee Wei Wong, (US); Ying Li, (US); Jiangjun Zheng, (US); Daniel J. Rogers, Baltimore, MD (US)

(72) Inventors: Chee Wei Wong, (US); Ying Li, (US); Jiangjun Zheng, (US); Daniel J. Rogers, Baltimore, MD (US)

(73) Assignee: THE JOHNS HOPKINS UNIVERSITY, Baltimore, MD (US)

(21) Appl. No.: 13/586,135

(22) Filed: Aug. 15, 2012

Related U.S. Application Data
(60) Provisional application No. 61/524,055, filed on Aug. 16, 2011.

(51) Int. Cl. G01V 7/02

(52) U.S. Cl. 73/382 G

(57) ABSTRACT

An apparatus for measuring a gravitational force includes an optomechanical oscillator that deforms under the gravitational force to cause a shift in resonance associated with the optomechanical oscillator.

### CROSS-REFERENCE TO RELATED APPLICATION

This application claims priority to and the benefit of U.S. Provisional Application No. 61/524,055 filed on Aug. 16, 2011, the entire contents of which are hereby incorporated herein by reference.

### STATEMENT OF GOVERNMENTAL INTEREST

Certain research which gave rise to this invention was made with government support under ORCHID contract awarded by the Defense Advanced Research Projects Agency (DARPA). The government may retain certain rights in the invention.

### BACKGROUND

Exemplary embodiments of the present disclosure generally relate to gravimeters, and more specifically to exemplary chip-scale high-performance gravimeters having cavity optomechanics.

There are generally three main classes of gravimeters including: (a) laser or atom interferometers using timed measurements, (b) cryogenic superconducting levitated masses, and (c) spring-type gravimeters. Laser interferometers have been implemented commonly for precision metrology across many scales and allow absolute gravimetry measurements with 1 to 10 μGal accuracies. Typically, laser interferometers involve timed and multiple-sampled measurements with calibrated or stabilized lasers, including locked to atomic clocks, to measure the free-fall of a reflecting body. Recent advances, for example, have used cold atom interferometry to determine the gravitational redshift to an accuracy of 7×10⁻⁹, and have improved precision of the gravitational constant to 1×10⁻⁴, or the gravity to a sensitivity of 100 ng per shot. With the interferometric or timed measurements, however, significant isolation from the environment—e.g., for laser stabilization or cooling—is often required, which might hinder portability or rugged field deployment realizations.

Superconducting gravimeters typically have low thermodynamical noise and low-drift, which can be due to the inherent stability of persistent currents in the superconductor, stability of the magnetic gradient produced in the superconducting coil, stability of the (e.g., a few grams) mechanical proof mass, and insensitivity to ambient perturbations. Superconducting gravimeters, however, typically operate at cryogenic temperatures at ˜4.2 K or lower that even in a closed-cycle cryostat requires ˜1 kW power for helium liquefaction, bringing challenges outside the laboratory environment.

The third class of gravimeters provides the spring-type approach for relative inertial force measurements. This approach is generally the most well-deployed. Prior work in the bulk involved simply an inclined spring to a cantilever beam (e.g., 10 cm spring) that gives a ˜100 nm displacement for an ˜10 ng relative gravity difference. This displacement can be sensed optically. The ensuing linearity about the zero-displacement point can provide a large measurement range; the use of quartz beams can alleviate concerns such as, e.g., hysteresis and fatigue in the sensor. This baseline design has been continuously modified and updated by, for example, Scintrex and sister company Micro-g LaCoste, encompassing applications such as, e.g., mapping the deep ocean seafloor morphologies. In one particular implementation, the recent GPHONE® can achieve, for example, 100 μGal resolution, 1 μGal precision with a system noise of 3 μGal/\sqrt{Hz}, 7 Gal range and 1.5 mGal/month drift. This bulk unit can also include a rubidium clock to synchronize to the global positioning system. However, a relatively small, yet still portable and robust gravimeter, such as a compact chip-scale gravimeter, has not yet been developed.

### BRIEF SUMMARY OF SOME EXAMPLES

Accordingly, some example embodiments may enable the provision of a chip-scale high-performance gravimeter through cavity optomechanics and methods for using the same. Exemplary embodiments of the present disclosure may provide, for example, a compact and array-scalable optical readout gravimeter, with, for example, 10 μGal/Hz^{1/2} (or ˜10 ng/Hz^{1/2}) noise levels at 20 mHz sampling rates, and methods for using the same. The cavity optomechanical measurement sensitivity (up to ˜5×10⁻¹⁷ m/Hz^{1/2}) can benefit, for example, from the low amplitude and phase noise of coherent laser sources. This exemplary approach can extend, for example, prior work on cavity optomechanics, such as, e.g., photonic crystal based slot-cavities for laser cooling of mesoscopic states, and nonclassical phase control of phonon states through coupled cavity optomechanical modes.

In one example embodiment, an apparatus for measuring a gravitational force is provided. The apparatus may include at least one optomechanical oscillator structured to deform under the gravitational force to cause a shift in resonance associated with the at least one optomechanical oscillator.

In another example embodiment, a method of determining a gravitational force is provided. The method may include providing at least one first radiation to at least one optomechanical oscillator where the at least one optomechanical oscillator is structured to deform under the gravitational force to cause a shift in resonance associated with the at least one optomechanical oscillator. The method may further include receiving at least one second radiation from the at least one optomechanical oscillator where the at least one second radiation is associated with the shift in the resonance. The method may further include determining the shift in the resonance based on the first and second radiations.

In another example embodiment, a non-transitory computer readable medium for determining a shift in a resonance associated with at least one optomechanical oscillator is provided. The computer readable medium may include instructions stored therein and may be accessible by a hardware processing arrangement. When the processing arrangement executes the instructions, the processing arrangement may be configured to perform at least one procedure that may include directing at least one first radiation to at least one optomechanical oscillator where the at least one optomechanical oscillator is structured to deform under the gravitational force to cause a shift in resonance associated with the at least one optomechanical oscillator. The at least one procedure may further include receiving at least one second radiation from the at least one optomechanical oscillator where the at least one second radiation is associated with the shift in the resonance. The at least one procedure may further include determining the shift in the resonance based on the first and second radiations.

### BRIEF DESCRIPTION OF THE SEVERAL VIEWS OF THE DRAWING(S)

Having thus described example embodiments of the invention in general terms, reference will now be made to the accompanying drawings, which are not necessarily drawn to scale, and wherein:

FIG. 1, which includes FIGS. 1A, 1B and 1C, illustrates an example of a chip-scale optical oscillator assembly for optomechanical gravimetry according to an example embodiment;

FIG. 2 illustrates a view of a photonic crystal that may be used to form an optomechanical cavity of an example embodiment;

FIG. 3, which includes FIGS. 3A to 3F, illustrates exemplary optical cavity modes of a mode-gap air-slot cavity from finite-difference time-domain and band structure calculations according to example embodiments;

FIG. 4 illustrates an exemplary block diagram of a measurement setup that may be employed for phase-shift detection according to an example embodiment of a chip-scale optical gravimeter;

FIG. 5 shows an exemplary flow diagram of an exemplary procedure according to an exemplary embodiment; and

FIG. 6 shows an exemplary block diagram of a system according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

Some example embodiments may enable the provision of a chip-scale gravimeter that may be small and portable, while still providing a relatively high degree of sensitivity. Some embodiments may provide a mass attached to an optomechanical cavity. The impact of gravity on the mass may cause properties of the optomechanical cavity to be altered. For example, if gravity increases, the mass may sag more and cause the width of the cavity to increase. As the cavity dimensions change, the properties of the cavity relative to modulation of a laser passed therethrough may also change. By monitoring changes in the modulation, a determination may be made as to the corresponding change in gravity that caused the change in modulation. Furthermore, example embodiments may couple a non-linear response to the optical field coupled with the small mode volume to provide noise cancellation that increases sensitivity.

The provision of an accurate and sensitive gravimeter that is also portable may enable the gravimeter to be advantageously employed in a number of environments outside of the laboratory. For example, some example embodiments may be useful in connection with conducting large-scale surveys regarding changes in gravitational fields underground, which may be used in connection with oil and gas exploration. Some embodiments may also be useful in connection with performing earth observations relating to geophysics research. Example embodiments may also be employed to perform tunnel detection and underground structure surveys. Such surveys may be useful for national or homeland security applications as well as the mining industry for assessment of the stability of underground structures. In some cases, example embodiments may be used in marine navigation to obtain precise gravity data for global navigation. Many other uses are also possible, and thus the examples above should not be seen as limiting relative to the scope of example embodiments.

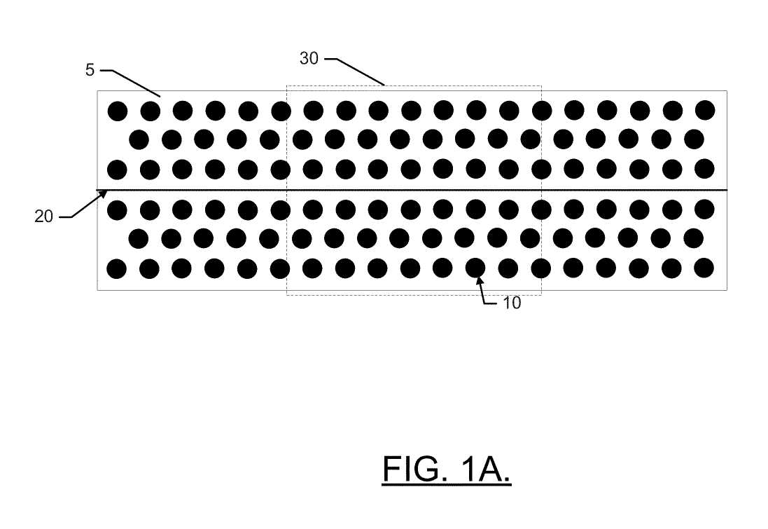

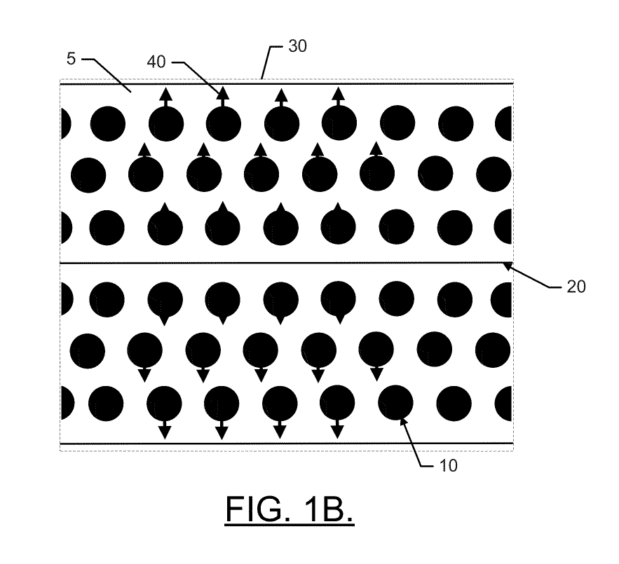

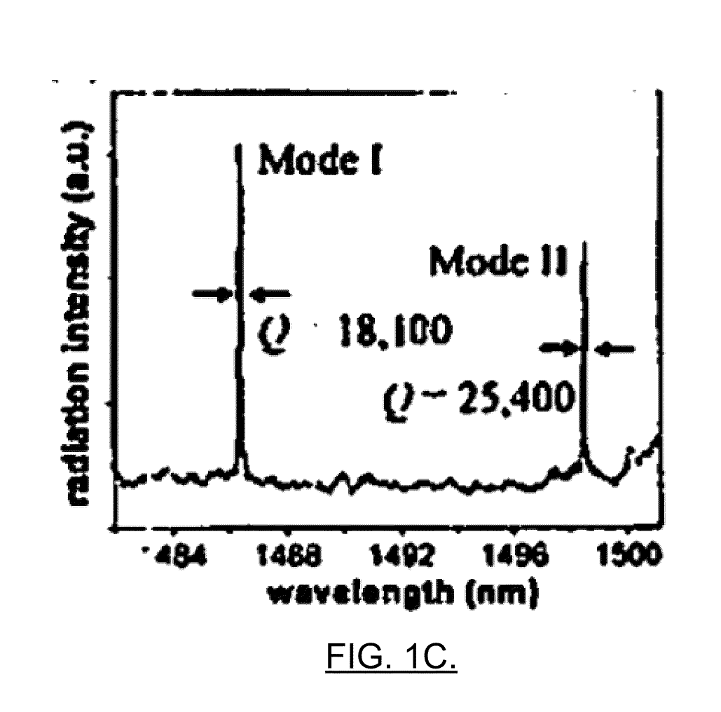

FIG. 1, which includes FIGS. 1A, 1B and 1C, illustrates an example of a chip-scale optical oscillator assembly for optomechanical gravimetry according to an example embodiment. In this regard, FIG. 1A illustrates a scanning electron micrograph (SEM) of mode-gap air-slot cavities. Meanwhile, FIG. 1B illustrates a zoomed in view of the SEM of FIG. 1A and FIG. 1C illustrates example measured resonances through collected radiation according o one example embodiment.

FIGS. 1A and 1B illustrate a plurality of holes 10 disposed within a crystal material (e.g., a photonic crystal 5) such as silicon on opposite sides of a slot 20 to form an optomechanical cavity. The holes 10 are generally disposed in a pattern on opposing sides of the slot 20. The holes 10 essentially form mirrors so that the slot 20 may form a waveguide through which laser energy may be provided. FIG. 1B shows a zoomed in view of portion 30 of the optical oscillator assembly of FIG. 1A. As shown in the portion 30, the holes 10 are displaced to create localized cavity resonances, for example, with a differential shift of d_{A}=14 nm, d_{B}=9 nm, and d_{C}=5 nm. The small arrows 40 in FIG. 1B illustrate the displacement of the holes 10 in this region (i.e., portion 30). The displacement of the holes 10 in the design causes a different index of refraction to be encountered in the portion 30 where the displaced holes are provided.

The resonance characteristics of the slot 20 are dependent upon the width of the slot. Thus, as a mass that may be attached to the optical oscillator assembly is affected by gravity to make the mass sag, the width of the slot 20 may be altered. The alteration of the width of the slot 20 may then be detected as a change in resonance characteristics of the cavity. For example, the response of the mass to the gravitational field may cause a change in the width of the slot 20. As the slot flexes in response to the impact of the gravitational field on the mass, a change in the amplitude and phase of laser energy transmitted through the slot 20 may be detected. The change in amplitude and phase of the laser energy may be indicative of the modulation of the laser energy as caused by a change in the gravitational field.

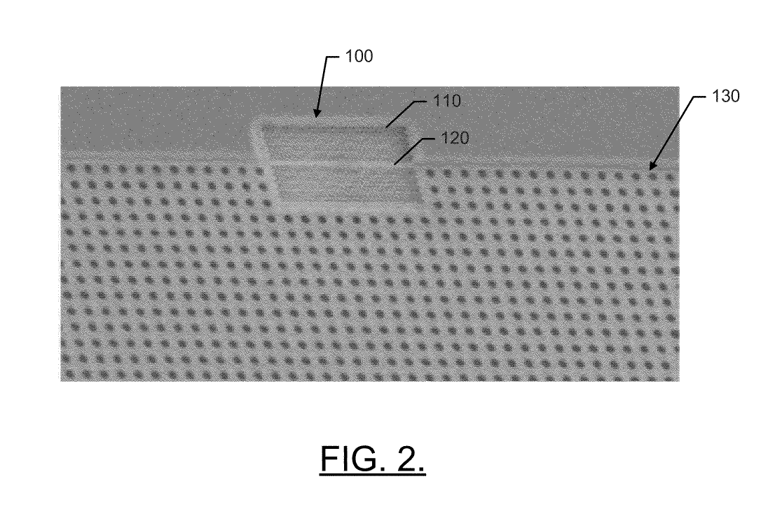

FIG. 2 illustrates a view of a photonic crystal 100 that may be used to form an optomechanical cavity of an example embodiment. As shown in FIG. 2, the photonic crystal 100 has holes 110 disposed on opposite sides of slot 120, and the photonic crystal is attached to a large mass 130. As indicated above, as the mass 130 is impacted by the gravitational field, the width of the slot 120 may be altered and thereby also the modulation experienced as laser energy is passed through the slot 120 (e.g., left to right as seen in FIG. 2) is changed. By monitoring phase and amplitude changes indicative of the modulation changes, changes in gravitational field may be determined.

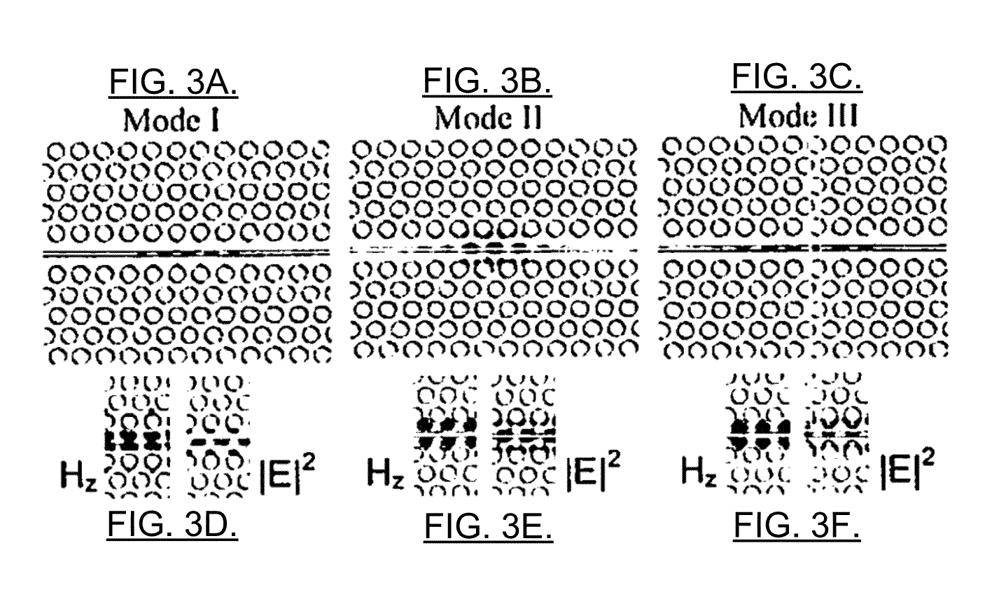

FIG. 3, which includes FIGS. 3A to 3F, illustrates exemplary optical cavity modes of a mode-gap air-slot cavity from finite-difference time-domain and band structure calculations according to example embodiments. FIGS. 3A, 3B and 3C illustrate |E|² spatial distribution a modes I, II and III, respectively. Meanwhile, FIGS. 3D, 3E and 3F illustrate corresponding first three slot photonic crystal waveguide modes, with Hz and |E|² distributions illustrated from band structure calculations.

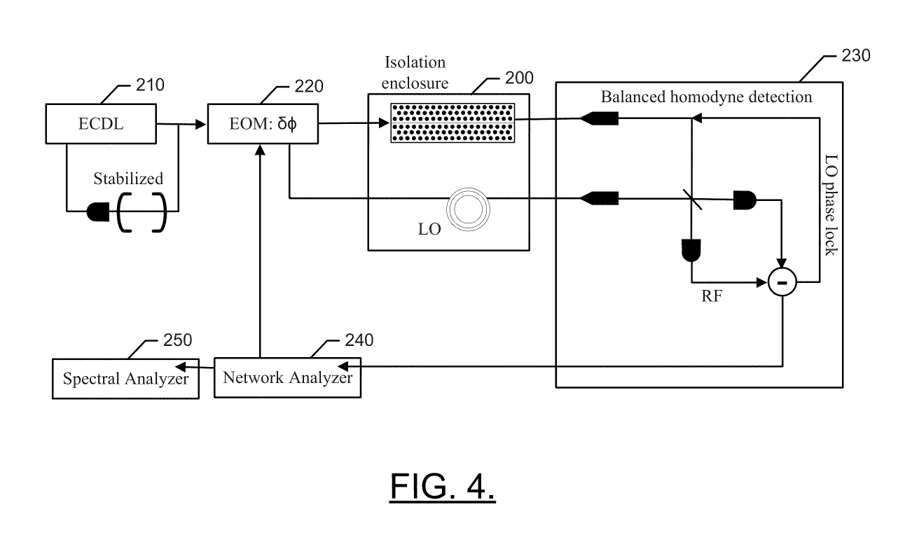

FIG. 4 illustrates an exemplary block diagram of a measurement setup that may be employed for phase-shift detection according to an example embodiment of a chip-scale optical gravimeter. As shown in FIG. 4, an isolation enclosure 200 may be provided to contain the chip-scale optical oscillator assembly for optomechanical gravimetry of FIGS. 1 and 2. The isolation enclosure may be fed by an external cavity diode laser (ECDL) 210 via an electro-optical modulator (EOM) 220, which may act as a phase shifter. A detection circuit 230 may be provided for balanced homodyne detection, which may be coupled to a network analyzer 240 and a spectral analyzer 250. The apparatus of FIG. 4 may employ a balanced homodyne detection implemented Mach-Zehnder fiber interferometer and the EOM phase-shifter may facilitate measurement calibration.

Exemplary embodiments similar to those presented above in FIGS. 1 and 2 may provide a chip-scale gravimeter that can be based on, for example, the high-Q/V air-slot photonic crystal mode gap cavity examined for cavity optomechanics. This exemplary optomechanical oscillator may have a loaded optical Q in excess of 10⁴ measured (10⁶ theory) while preserving, for example, a deeply-subwavelength optical modal volume V of ˜0.02(λ/n)³. The gravitational force may serve to displace (δx) the mechanical oscillator position as described above. Nanobeams can be provided for a mode displacement that is either common or differential (e.g., such that one nanobeam can be much more compliant than the other)—both of which can result in a perturbation to the optical cavity resonance. For a 100 μg silicon (or silicon nitride) optomechanical cavity with 50 kHz fundamental mechanical mode resonance, e.g., an approximate 4 nm displacement can be observed under 1 g acceleration. These displacements are typically in the first-order perturbative regime for the optical resonance. The resonance shift may depend linearly on the air-slot spacing (denoted as s in FIG. 1) at a rate, for example, of ˜−0.88 nm wavelength shift per nm of the mechanical oscillator displacement (or equivalently ˜3.5 nm wavelength shift for a differential 1 g acceleration). The perturbed optical resonance may be detected through the second mode (II) of the cavity (FIGS. 1C and 3), measuring the differential transmitted intensity.

Exemplary Noise Considerations: The mechanical oscillator displacement sensitivity in such high-Q/V systems can be remarkable, with an experimentally-observed minimal photoreceiver-noise-limited sensitivity of, for example, ˜5×10⁻¹⁷ m/Hz^{1/2}, or about four times the standard quantum limit. In a homodyne detection, the theoretical shot-noise-limited displacement sensitivity of the cavity optomechanical system can be described by.

$$δ {x}_{min} ≅ \frac{λ}{s π Q \sqrt{η ρ / ℏ ω}}$$

For the exemplary cavity Q of ˜40,000, P at 1 μW and scaling coefficient η of 0.5, the displacement sensitivity can reach ˜8×10⁻¹⁹ m/Hz^{1/2} theoretically, which can be even feasible for zero-point motion detection with a 1 kHz resolution bandwidth, if the readout laser has quantum limited amplitude and phase noise. The practical noise contributions can arise, for example, from thermomechanical Brownian noise, photoreceiver noise, shot noise, and quantum backaction noise from optical gradient force fluctuations.

Exemplary embodiments of the present disclosure may also facilitate Pound-Drever-Hall locking and detection—this phase sensitive detection technique may allow a direct measurement of nanomechanical position (see example measurement setup in FIG. 3). This can facilitate the characterization of the displacement noise spectrum and the thermomechanical Brownian motion [given, e.g., as 2k_{B}Tₛₑₙₛₑ/m_{eff}ΩₘΓₘ where Tₛₑₙₛₑ can be the effective temperature of the sensing (e.g. fundamental) mechanical mode, m_{eff} can be the effective mass of the mechanical mode, Ωₘ can be the resonance frequency, and γₘ can be the mode decay rate] of the chip-scale optomechanical gravimeter.

Exemplary Resonant detection: It is likely that a resonantly driven measurement may provide a better signal-to-noise ratio to achieve the 10⁻⁸ sensitivities desired for the gravimeter. In the present case, the optical gradient force can drive the exemplary system on its RF mechanical resonance Ωₘ. The optical gradient force may arise from, for example, the evanescent optical fields and can be calculated through the Maxwell stress tensor and first-order perturbation theory. The optical force may give rise to an optical stiffening of the RF resonance, a resonance shift (Ωₘ¹-Ωₘ) that may depend on the gravity-induced slot displacement as

$${Ω}_{m}^{1} 2 = {Ω}_{m}^{2} + ( \frac{2 \vert {a}_{o} \vert {2}_{{g}_{om}^{2} ( δ x )}}{{Δ}^{2} {w}_{c} {m}_{x}} ) {Δ}_{o}^{1} ,$$

where the optomechanical interaction rate g_{gm} may be dependent on the gravity-induced slot displacement δx|aₒ|² may be the time-averaged energy in the optical cavity, Δ₀¹ the laser—cavity detuning, and Δ² ▪Δₒ¹^{²}+(Γₒ/2)² with Γₒ the optical cavity photon decay rate. For a fixed laser—optical resonance detuning, the input laser power can be swept; the resulting characteristic slope of the mechanical frequency optical stiffening may differ for varying gravitational forces.

High transduction sensitivity may be achieved by employing some example embodiments. This sensitivity may be achieved based at least in part on the low amplitude and phase noise of coherent laser sources, in addition to the resonant driving approach. Further, resonant nanomechanical oscillators—by going to higher frequencies—may facilitate mass sensing in the range of attograms to zeptograms (10⁻²¹ grams), equivalent to the inertia force of several xenon atoms or an individual kDa molecule. The frequency shift can be read out electrically. This differential inertia force sensitivity can range ˜ from 1 part in 10⁵ to 1 part in 10¹², and may be likely to reach 10⁻⁸ sensitivities desired in this gravimeter implementation. With two-available optical cavity modes and wavelength-division multiplexing, a combined drive-and-sense protocol can also be implemented in the chip-scale optical gravimeter for compactness, noise normalization and robustness.

Exemplary Measurement considerations: The physical measurements and device nanofabrication can be examined, along with approaches to suppress the primarily noise sources. For eventual field deployment, commercially available vertical cavity surface emitting lasers with low relative intensity noise may be embedded. The exemplary chip gravimeter can be packaged in vacuum that can facilitate the resonant mass to be kept constant to avoid, for example, spurious frequency shifts, to attain a high quality factor mechanical resonance, and to avoid molecular dynamical noise. The exemplary sensor may also be placed in vibration-isolated mounts (such as, e.g., from Minus-K) so as to suppress seismic noise. With an exemplary sampling rate in the range of 20 mHz and the tens to hundreds kHz resonances, e.g., a large sampling to average down the noise fluctuations can be feasible, although long-term (e.g., in the period of days) drift corrections are preferably carefully considered. A referencing between two (or more) gravimeters on the same chip should normalize out much of the seismic noise, while facilitating more rapid data acquisition. Readout noise and resonant dynamic range can be examined, from nonlinear optical stiffening at the high end (e.g., to avoid nonlinear Duffing instability), to source and detector shot noise at the low end. Thermoelectric cooling of the chip can also be examined for possible noise reductions. For exemplary absolute measurements, the exemplary chip-scale gravimeter can also be calibrated at a known-gravity site or with a laser-interferometer absolute gravimeter, although calibration variability is preferably carefully examined. The chip-scale implementation can also provide arrayed capability, such as for tensor gradiometer and parallel multiple measurements for improved noise averaging and multi-modal functionality in the same compact package.

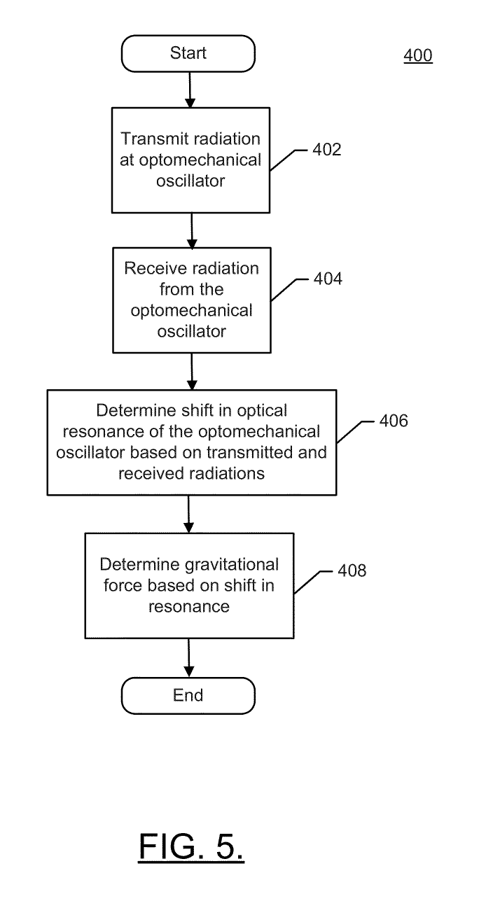

FIG. 5 shows an exemplary flow diagram of an exemplary procedure 400 according to an exemplary embodiment of the present disclosure. For example, as shown in FIG. 5, a radiation (e.g., a nanobeam) can be directed at an optomechanical oscillator at operation 402. The optomechanical oscillator may be similar to that which has been described above in connection with FIGS. 1-4. Thereafter, a resulting radiation from the optomechanical oscillator may be received at operation 404, and a shift in the resonance of the optomechanical oscillator may be determined at operation 406. The shift in the resonance of the optomechanical oscillator may be used to determine a gravitational force or field at operation 408.

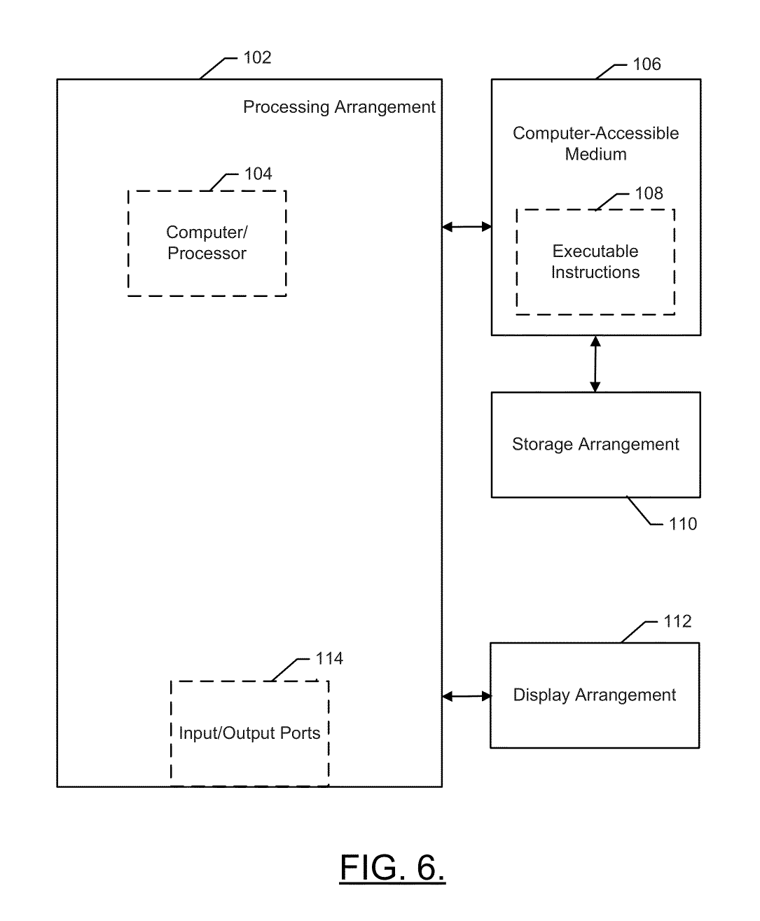

FIG. 6 shows an exemplary block diagram of an exemplary embodiment of a system according to the present disclosure. For example, exemplary procedures in accordance with the present disclosure described herein can be performed by a processing arrangement and/or a computing arrangement 102. Such processing/computing arrangement 102 can be, e.g., entirely or a part of, or include, but not limited to, a computer/processor 104 that can include, e.g., one or more microprocessors, and use instructions stored on a computer-accessible medium (e.g., RAM, ROM, hard drive, or other storage device).

As shown in FIG. 6, e.g., a computer-accessible medium 106 (e.g., as described herein above, a storage device such as a hard disk, floppy disk, memory stick, CD-ROM, RAM, ROM, etc., or a collection thereof) may be provided (e.g., in communication with the processing arrangement 102). The computer-accessible medium 106 may store executable instructions 108 thereon. In addition or alternatively, a storage arrangement 110 can be provided separately from the computer-accessible medium 106, which may provide the instructions to the processing arrangement 102 so as to configure the processing arrangement to execute certain exemplary procedures, processes and methods, as described herein above, for example. The exemplary instructions and/or procedures may be used for determining a shift in a resonance associated with at least one optomechanical oscillator based on, e.g., the exemplary procedure described herein and associated with the exemplary embodiment of FIG. 5.

Further, the exemplary processing arrangement 102 can be provided with or include an input/output arrangement 114, which can include, e.g., a wired network, a wireless network, the internet, an intranet, a data collection probe, a sensor, etc. As shown in FIG. 6, the exemplary processing arrangement 102 can be in communication with an exemplary display arrangement 112, which, according to certain exemplary embodiments of the present disclosure, can be a touch-screen configured for inputting information to the processing arrangement in addition to outputting information from the processing arrangement, for example. Further, the exemplary display 112 and/or a storage arrangement 110 can be used to display and/or store data in a user-accessible format and/or user-readable format.

It should be understood that the exemplary procedures described herein can be stored on any computer accessible medium, including a hard drive, RAM, ROM, removable disks, CD-ROM, memory sticks, etc., and executed by a processing arrangement and/or computing arrangement which can be and/or include a hardware processors, microprocessor, mini, macro, mainframe, etc., including a plurality and/or combination thereof. In addition, certain terms used in the present disclosure, including the specification, drawings and claims thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously.

Accordingly, some example embodiments may be provided to employ a relatively small and potentially mobile assembly for conducting gravimetry measurements. In this regard, some example embodiments may provide a chip-scale gravimeter that is capable of measuring relatively small and/or slow changes in gravitational fields with a relatively high degree of sensitivity. Example embodiments may provide a small space for light to pass through with a strong non-linear interaction employed to couple optic and mechanical modes. The non-linear response to the optical field coupled with the small mode volume of example embodiments, which small mode volume may be provided as the volume between a slot and mirror-like holes formed on either side of the slot within a photonic crystal, may provide noise cancellation that provides superior sensitivity for example embodiments.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. An apparatus for measuring a gravitational force comprising:
at least one optomechanical oscillator structured to deform under the gravitational force to cause a shift in resonance associated with the at least one optomechanical oscillator.

2. The apparatus of claim 1, further comprising at least one radiation source arrangement configured to direct at least one first radiation toward the at least one optomechanical oscillator.

3. The apparatus of claim 2, further comprising at least one detecting arrangement configured to receive or detect at least one second radiation from the at least one optomechanical oscillator.

4. The apparatus of claim 3, further comprising at least one hardware processing arrangement configured to determine the shift in resonance associated with the at least one optomechanical oscillator based on the first and second radiations.

5. The apparatus of claim 4, wherein the at least one hardware processing arrangement is further configured to determine the gravitational force based on the shift in the resonance.

6. The apparatus of claim 1, wherein the at least one optomechanical oscillator includes at least one optomechanical cavity.

7. The apparatus of claim 6, wherein the at least one optomechanical cavity includes at least one slot, and wherein the shift in the resonance is a function of a width of the at least one slot.

8. The apparatus of claim 6, wherein the at least one optomechanical cavity includes a high Q/V air-slot photonic crystal mode gap cavity.

9. The apparatus of claim 6, wherein a mass is coupled to the optomechanical cavity such that a change in the gravitational force impacts the mass by correspondingly changing a size of the optomechanical cavity to cause the shift in the resonance.

10. The apparatus of claim 1, wherein the at least one optomechanical oscillator comprises a chip-scale optical oscillator employing a material having a nonlinear response to an optical field to cause the shift in resonance based on a nonlinear interaction coupling optical and mechanical modes.

11. The apparatus of claim 1, wherein the at least one optomechanical oscillator comprises a chip-scale optical oscillator employing a photonic crystal defining a slot having holes formed in the photonic crystal on opposite sides of the slot for form a waveguide for an optical signal to travel through the slot

12. The apparatus of claim 11, wherein a width of the slot is changeable responsive to a change in the gravitational force such that a change in the width of the slot causes the shift in the resonance, and wherein the shift in resonance is measured to provide an indication of the change in the gravitational force.

13. A method of determining a gravitational force, the method comprising:
providing at least one first radiation to at least one optomechanical oscillator, the at least one optomechanical oscillator being structured to deform under the gravitational force to cause a shift in resonance associated with the at least one optomechanical oscillator;
receiving at least one second radiation from the at least one optomechanical oscillator, wherein the at least one second radiation is associated with the shift in the resonance; and
determining the shift in the resonance based on the first and second radiations.

14. The method of claim 13, further comprising determining a change in the gravitational force based on the shift in the resonance.

15. The method of claim 13, wherein determining the shift comprises measuring modulation associated with an optomechanical cavity, the modulation being determined by comparing the first and second radiations.

16. The method of claim 15, wherein measuring the modulation comprises measuring an amplitude and phase of the second radiation.

17. A non-transitory computer readable medium for determining a shift in a resonance associated with at least one optomechanical oscillator, the computer readable medium including instructions stored therein and accessible by a hardware processing arrangement, wherein, when the processing arrangement executes the instructions, the processing arrangement is configured to perform at least one procedure comprising:
directing at least one first radiation to at least one optomechanical oscillator, the at least one optomechanical oscillator being structured to deform under the gravitational force to cause a shift in resonance associated with the at least one optomechanical oscillator;
receiving at least one second radiation from the at least one optomechanical oscillator, wherein the at least one second radiation is associated with the shift in the resonance; and
determining the shift in the resonance based on the first and second radiations.

18. The computer readable medium of claim 17, wherein the processing arrangement is further configured to determine a change in the gravitational force based on the shift in the resonance.

19. The computer readable medium of claim 17, wherein determining the shift comprises measuring modulation associated with an optomechanical cavity, the modulation being determined by comparing the first and second radiations.

20. The computer readable medium of claim 19, wherein measuring the modulation comprises measuring an amplitude and phase of the second radiation.
